(19) United States
(12) Patent Application Publication
(10) Pub. No.: US 2013/0276925 A1
(43) Pub. Date: Oct. 24, 2013

(54) PRESSURE REGULATING DEVICE WITH DETECTION OF THE NEUTRAL POSITION

(71) Applicants: Didier Merletti, Saint Sorlin (FR); Jean-Luc Boudou, Saint Andre De Corcy (FR)

(72) Inventors: Didier Merletti, Saint Sorlin (FR); Jean-Luc Boudou, Saint Andre De Corcy (FR)

(73) Assignee: BOSCH REXROTH D.S.I., Venissieux (FR)

(21) Appl. No.: 13/977,955

(22) PCT Filed: Jan. 9, 2012
(86) PCT No.: PCT/FR2012/050056

§ 371 Date: Jul. 2, 2013

(30) Foreign Application Priority Data
Jan. 7, 2011 (FR) 11/50116

(51) Int. Cl. F15B 13/043

(52) U.S. Cl. CPC F15B 13/043
USPC 137/625.64; 91/459

(57) ABSTRACT

The present invention relates to a pressure regulating device (1), in particular a hand- or foot-operated hydraulic controller for a heavy construction machine, characterised in that it comprises an electrical or electronic means (20) for determining the position of the actuator (18) or the push button (7) including a proportional sensor comprising, on the one hand, a mobile member (21) following the movement of the actuator (18) or a push button (7) and, on the other hand, a contactless means (22) for detecting the position of the mobile member (21) secured to the body (2), as well as an anti-tilting system, a load sensing system for controlling the pressure increase, the idling delivery of the heat engine, or a flow sharing system, comprising such a pressure regulating device (1).

### TECHNICAL FIELD

The present invention relates to a pressure regulating device, notably a hand- or foot-operated controller for a public works machine, as well to as an anti-tilting system, a system for controlling the rise in pressure of the [symbol] load sensing [symbol] type, for leaving the idling mode of the heat engine or for the flow distribution of the [symbol] flow sharing [symbol] type, including such a device.

### BACKGROUND

These pressure regulating devices are in particular used for ensuring the driving of various hydraulic functions such as setting various receiving members installed on-board these public works machines into motion.

Such hydraulic distribution devices are well-known to one skilled in the arts and for example are described in document FR 2 376 978.

The pressure regulating devices of the type described in the preceding document include a body comprising at least one cavity extending between an end opening onto at least one upper face of the body and a bottom opposite to the opening end,
at least one regulating unit mounted in the body, and comprising a pusher extending between a head and a foot and being at least partly housed in said at least one cavity of the body along an axial direction (X-X), said pusher being laid out for producing a reciprocal movement between a determined position of equilibrium and variable recessed and/or protruding positions relatively to the equilibrium position,
an actuator extending along an axial direction (Y-Y), intended to be actuated by an operator and comprising a transverse skirt, said actuator being pivotally mounted relatively to the body facing the upper face of said body in order to control the reciprocal movement of said pusher, the skirt bearing upon the head of said pusher, and the axis (Y-Y) of the actuator forming with the axis (X-X) of the pusher a variable angle between a neutral position and variable positions tilted relatively to the neutral position in two opposite directions relatively to the neutral position of the actuator.

With these regulation devices, it is generally possible to achieve different types of actions, for example the control of an actuator or of a particular hydraulic motor, by means of a rotary reciprocal movement of the actuator around two different axes around its neutral position.

By each rotary reciprocal movement around one of the two axes, it is possible to actuate two regulating units, one of which is in intended for carrying out a given action and the other one is intended for carrying out the opposite action, for example a regulating unit controls the outward movement of the actuating rod or the clockwise rotation of the hydraulic motor and the other one controls the retraction of the actuator rod or the anti-clockwise rotation of the hydraulic motor.

Placement of such a pressure regulating device type with regulating units equipped with a pressure sensor delivering electric signals representative of the pressure exerted by the fluid on the walls of the cavity of the body is notably known from document U.S. Pat. No. 7,753,078.

This pressure regulating device is satisfactory in that it provides real time information on the state in which is found the pressure regulating device at the moment when the measurement is carried out.

These pieces of information may be used for controlling solenoid valves or else for providing indications on the positioning of the actuator, notably on its direction and its tilt.

Nevertheless, a pressure regulating device equipped with such sensors implies additional machining in the cavity for mounting the sensor and its associated electronics, which form potential paths for additional hydraulic leaks.

Further, such a configuration combines both hydraulic and electronic functions, making the electronic functions dependent on the hydraulic functions.

On the other hand, the behavior of a hand- or foot-operated hydraulic controller is not linear over the whole of the travel of its pusher and includes several distinct phases:
a first phase or dead travel corresponding to the emergence of the neutral position of the pusher in which the pusher travel does not generate any increase in pressure at the output of a regulating unit,
a second phase corresponding to a regulation jump in which the pressure at the output of the regulating unit suddenly increases, and
a third phase corresponding to a more linear operation in which the pressure at the output of the regulating unit becomes proportional to the travel of the pusher of the hand- or foot-operated hydraulic controller.

The second phase, because of the sudden and unpredictable increase in pressure at the output of the regulating unit, is a problem, notably in the application of anti-tilting systems based on the cutting off of aggravating movements and preventing a hydraulic machine equipped with a pressure regulating device from further aggravating these movements by only allowing actuation of non-aggravating maneuvers.

Indeed, the second phase may further aggravate the movement beyond an alert threshold parameterized in an anti-tilting system.

The second phase also leads to a delay in the application of the load of the hydraulic pump in pressure raising systems controlled by distribution valves of the load sensing type allowing the hydraulic circuit to remain at a low pressure while the hand- or foot-operated controller is in a neutral position, thereby limiting energy losses and in particular fuel, the rise in pressure of the hydraulic circuit only being carried out once the hand- or foot-operated controller has left its neutral position.

The second phase also leads to a delay in systems for managing the heat engine speed, with the goals of optimizing energy consumption by bringing the speed of the heat engine to idling speed when the consumed power is low.

Document FR 2 801 350 describes a pressure regulating device of the hand-operated type.

This device comprises means for detecting the passage of the actuator beyond its dead travel, the detection of a controlled movement being carried out before the fluidic control has become functional.

With this device, it is possible to detect the passage of an actuator beyond its dead travel in the second operating phase of a hand- or foot-operated controller.

This document also shows an embodiment in which the passage into the second operating phase of the hand-operated controller, corresponding to its actuator leaving the dead travel, is detected by means of the movement of a drawer actuated via the action of the pusher on a spring.

However, these different systems do not allow application of a regulation based on the position of the actuator or of the pusher since they only detect the passage from a first state to a second operating state of the device.

### BRIEF SUMMARY

The disclosure solves all or part of the drawbacks mentioned above.

For this purpose, the invention provides a pressure regulating device of the aforementioned type characterized in that it includes electrical or electronic means for determining the position occupied by the actuator or the pusher comprising a proportional type sensor including a member which may move according to the movement of the actuator or a pusher on the one hand and means for contactless type detection of the position of the moveable member, secured to the body, on the other hand, the moveable member being interdependent on the movement of a pusher and positioned in a cavity of the body, the detection means being placed outside said cavity.

With this arrangement, it is possible to separate the hydraulic functions and the electronic functions of the pressure regulating device on the one hand, and to be able to anticipate the behavior of the hand- or foot-operated hydraulic controller on the other hand, in particular during passing from its first phase to its second phase, but also in the third operating phase and the following phases.

Such a proportional device gives the possibility of detecting the position of the actuator or of the pusher during the movement of the latter over the whole of their travel or over a significant portion of the latter.

Further, this arrangement gives the possibility of supervising the hydraulic stage and of arbitrating the priorities in the movement of different pushers in the case when the pressure regulating device would have more than one pusher.

Such a regulating device also gives the possibility of anticipating the loading of the hydraulic pump in pressure raising systems controlled by distribution valves of the [symbol] load sensing [symbol] type. By a system of the [symbol] load sensing [symbol] type is meant a system for controlling flow rates independently of the load.

Such a regulating device also allows application of a device of the [symbol] flow sharing [symbol] type, i.e. an anti-flow saturation system allowing control of the useful flow distribution in systems comprising several pressure regulating devices. In such a system of the [symbol] flow sharing [symbol] type, when the sum of the flow rates requested by the receivers is greater than the total flow rate which may be provided by the source (for example a pump), each receiver receives a flow rate of less than the requested flow rate but proportional to the request, so as to give the possibility of continuing to provide a flow to the whole of the affected receivers. Within this scope, regulation of the flow in the receiver may be directly achieved depending on information on the displacement of the pusher.

According to an embodiment, the moveable member comprises at least one magnet and the detection means comprise an electronic element for detecting the magnet.

According to an embodiment, the means for determining the position of the actuator comprise a Hall effect sensor.

According to an embodiment, the pressure regulating device includes several distinct operating phases in each of which the output pressure of the regulating unit is determined according to the positioning of the actuator or of the pusher, the electrical or electronic means for determining the position occupied by the actuator or pusher being laid out so as to determine the position occupied by the actuator or pusher over at least one portion of the two operating phases.

As an example, the different operating phases may be formed by a first phase, a so-called dead travel phase, a second regulation jump phase and a third phase defined beyond the regulation jump, which may notably be a substantially linear control phase and optionally other subsequent phases in particular corresponding to an end of travel.

With this arrangement, it is possible to utilize specific positioning ranges of the actuator or of the pusher.

Advantageously, the moveable member is mounted on an abutment-cup limiting the upward movement of the pusher to its equilibrium position while the detection means are mounted on a side face of the body facing said side face of the cavity of the body, facing which the moveable member is mounted.

According to an embodiment, when the actuator is in its neutral position, the moveable member is placed facing the detection means.

The invention also provides an anti-tilting system, for controlling a rise in pressure of the load sensing type, for leaving the idling mode of the heat engine, or for flow distribution of the flow sharing type, notably for a public works machine, including a pressure regulating device as described earlier.

Such a device may thus block the movement before the behavior of the hand- or foot-operated hydraulic controller starts its second phase, in the case when the latter would be able to cause an aggravating movement.

### BRIEF DESCRIPTION OF THE DRAWINGS

Anyway, the invention will be better understood with the description which follows, with reference to the appended schematic drawing illustrating as a non-limiting example, a pressure regulating device according to the invention.

FIG. 1 shows an embodiment of a pressure regulating device according to the invention.

FIG. 2 shows a first graphical illustration of the force or pressure at the output of a regulated unit of a pressure regulating device versus the travel of the pusher.

FIG. 3 shows a second graphical illustration of the force or pressure at the output of a regulated unit of a pressure regulating device versus the travel of the pusher.

FIG. 4 shows a third graphical illustration of the force or pressure at the output of a regulated unit of a pressure regulating device versus the travel of the pusher.

FIG. 5 shows a fourth graphical illustration of the force or pressure at the output of a regulated unit of a pressure regulating device versus the travel of the pusher.

FIG. 6 illustrates a use of the regulating device according to the invention.

### DETAILED DESCRIPTION

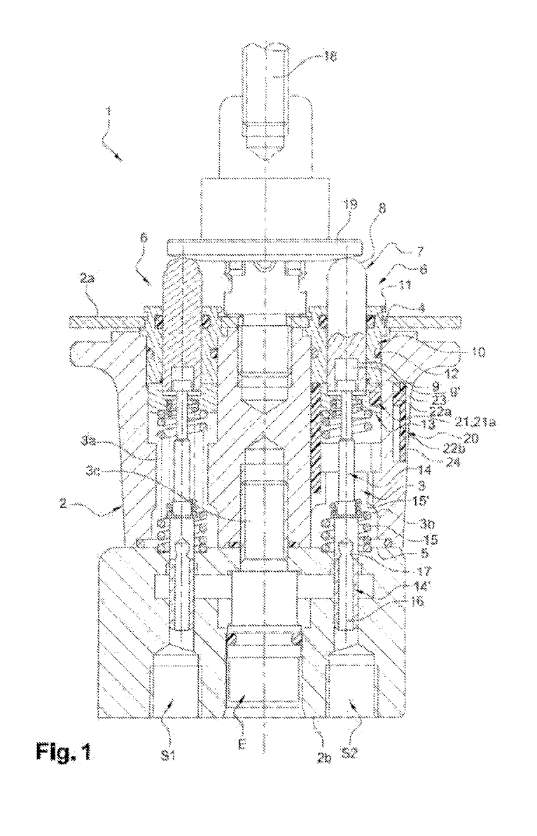

In the embodiments shown in FIG. 1, a pressure regulating device 1 includes a body 2 comprising two cavities 3a, 3b, extending between an end 4 opening onto an upper face 2a of the body 2 and a bottom 5 opening opposite to the end 4 opening onto a lower face 2b.

A third cavity 3c is, as for it, laid out so as to only open out onto the lower face 2b of the body 2 and to communicate via channels with each of the cavities 3a, 3b.

The third cavity 3c opening out onto the lower face 2b of the body 2 forms an entrance E for pressurized hydraulic fluid while both other cavities 2a, 2b opening out into the bottom 5 on the lower face 2b of the body each form an outlet S1, S2 for the regulated pressurized hydraulic fluid.

A fourth cavity (not shown), as for it, forms an outlet for the pressurized hydraulic fluid entering through the inlet E.

This cavity is connected to an outer hydraulic fluid tank, itself connected to a hydraulic pump bringing the pressurized hydraulic fluid back towards the inlet E.

Each pressure regulating device 1 comprises an actuator 18, for example the handle of a hand-operated hydraulic controller, producing a rotary reciprocal movement around an axis in order to be able to actuate two regulating units 6 mounted in the body 2.

Each regulating unit 6 comprises a pusher 7 extending between a head 8 and a foot 9, each pusher 7 being partly housed in one of the two cavities 3a, 3b of the body 2 along an axial direction (X-X), said pusher 7 being laid out for producing a reciprocal movement between a determined equilibrium position PE and a variable driven-in position.

It is quite understood that the present invention is not limited to embodiments only comprising two regulating units 6, but also relates to pressure regulating devices 1 with several regulating units 6, and in particular four combined 2×2 devices for example for side rotary movements and for vertical rotary movements.

The pressure regulating device 1 also comprises a guide 10 in the form of a hollow cylinder, crossed right through by the pusher 7 and inside which the pusher 7 moves with minimal play.

This guide 10 is immobilized in each cavity 3a, 3b, at the end 4 opening onto the upper face 2a of the body 2 and includes a first seal gasket 11 and a second seal gasket 12 ensuring the hydraulic seal interiorly and exteriorly to the guide 10, respectively.

In order to limit the upward movement of the pusher 7, an abutment-cup 13 is fitted onto the foot 8 of the pusher 7.

The invention is not limited to this type of abutment-cup 13 and may notably include means allowing an upward movement of the pusher towards its outward direction without this departing from the scope of the invention.

The foot 8 of the pusher 7 is extended with a plunger 14 crossing the abutment-cup 13, mounted so as to substantially oscillate along the same axial direction X-X as the pusher 7 and laid out for ensuring the pressure reducing function.

For this purpose, the plunger 14 is translationally moveable inside a cavity 9′ made at the foot 9 of the pusher 7.

A return spring 15 is interposed between the bottom 5 of each cavity 3a, 3b of the body 2 and the abutment-cup 13 fitted onto the foot 9 of the pusher 7.

A regulation spring 15′, with a smaller diameter than the return spring 15 and positioned co-axially with the latter, is interposed between the end of the plunger 14 and the abutment-cup 13.

This regulation spring 15′ exerts a return force against the pressure force exerted on the plunger 14.

Thus, the equilibrium of the plunger 14 depends on the compression of the return spring 15 imposed by the driving-in of the pusher 7 on the one hand and on the output regulating pressure to be delivered to a downstream receiving member connected to an outlet S1, S2 of the pressure regulating device 1 acting against the return force of the regulation spring 15′ on the other hand.

The plunger 14 comprises an active portion 14′ which intervenes for controlling the fluid pressure at the outlet S1, S2.

For this purpose, the active portion 14′ comprises an axial blind hole 16 opening into the cavity 3a, 3b in the direction of the outlet S1, S2 respectively as well as transversal orifices 17 laid out for putting different chambers present in the cavity 3a, 3b in communication with each other according to the driven-in position of the pusher 7.

It is thus that in the neutral position PN of the pusher 7, the pressurized fluid is directed towards ducts provided in the body 3, connected to a low pressure fluid area, for example to an oil tank and at the outlet of the neutral position PN, the pressurized fluid is directed towards one of the outlets S1 or S2.

Controlling the driving-in of the pusher 7 is achieved by means of an actuator 18 extending along an axial direction Y-Y, intended to be actuated by an operator and comprising a transverse skirt 19.

The actuator 18 is pivotally mounted relatively to the body 2 facing the upper face 2a of said body 2 in order to control the reciprocal movement of said pusher 7, the skirt 19 simply bearing upon the head 8 of said pusher 7, and the axis Y-Y of the actuator forming with the axis X-X of the pusher 7, a variable angle between a 0° value corresponding to the neutral position PN of the actuator 18 as well as at a determined equilibrium position PE of the pusher 7, and a value of less than 90° corresponding to a tilted position of the actuator 18 as well as to a variable driven-in or raised position of the pusher 7.

A pressure regulating device 1 according to the invention also comprises means 20 for determining the position of the actuator 18 between its neutral position PN and its tilted position.

These means 20 for determining the position of the actuator 18 are arranged so as not to interact with the hydraulic functions of the pusher regulating device 1.

These means 20 for determining the position of the actuator 18 preferably comprise a position sensor of the Hall effect type comprising a moveable member 21 and fixed detection means 22.

The detection means 22 comprise an electronic detection element or sensor 22a placed, contactless, in proximity to the moveable member 21, and an electronic board comprising a microcontroller or a processing device 22b giving the possibility of formatting the signals at the output of the sensor 22a or combining them in the case of several means 20 for determining the position of the actuator 18 on a same pressure regulating device 1 of the hand- or foot-operated hydraulic controller type.

These determination means are of the Hall effect position sensor type. Therefore, the moveable member 21, intended to be moveable, comprises a magnet 21a while the sensor 22a intended to be fixed in order to define a reference system for the moveable member 21, preferably comprises a detection chip 22a on which the Hall voltage is generated.

The signals delivered by the detection chip 22a depend on the relative distance separating it from the moveable member 21 of the detection means 22.

As illustrated in FIG. 8, the output signals of the device 22b for processing the signals at the output of the sensor 22a are utilized for driving another electric or electronic member, such as a solenoid valve 22c.

As an example, by using the device according to the invention, it is possible to use the solenoid valve, for example for controlling a pressure reducing device so as to cause pressure regulation in the circuit depending on the position of the actuator or of the pusher.

Thus, it is possible to apply a distribution of the flow on an installation comprising several actuators (flow sharing) or a regulation taking into account the load on the system (load-sensing).

As illustrated in FIG. 1, the magnet 21a is placed in the cavity 3a, 3b in a transverse housing 23 made on a side face of the abutment-cup 13 towards the outside of the pressure regulating device 1 while the detection means 22, and in particular the detection chip 22a, are mounted in a housing 24 made on a side face of the body 2 facing the magnet 21a when the actuator 18 of the pressure regulating device 1 is in its neutral position PN.

In this embodiment, only one processing unit 22b may be used for processing the whole of the signals stemming from the whole of the sensors 22a of a same pressure regulating device 1 of the hand- or foot-operated hydraulic controller type.

In other embodiments not shown, it becomes possible to design electronic boards 22b with programming, allowing anticipation of the movements of the pusher 7 and in particular of the second phase corresponding to a regulation jump in which the output pressure S1, S2 of a regulating unit 6 suddenly increases, these data being utilized by an anti-tilting system, a pressure raising system controlled by distribution valves of the [symbol] load sensing [symbol] type, a system for flow distribution of the [symbol] flow sharing [symbol] type, or further a system for leaving the idling speed mode of the heat engine.

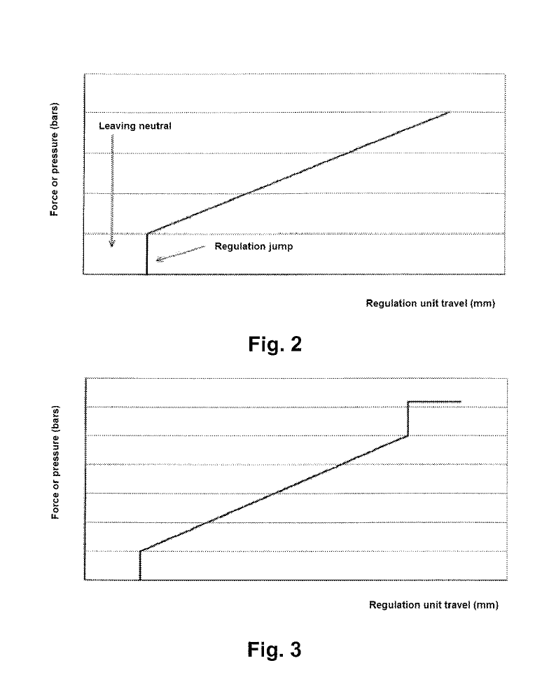

FIGS. 2, 3, 4 and 5 show a graphical illustration in which it is possible to distinguish the three phases described earlier of the behavior of a hand- or foot-operated hydraulic controller, i.e.
a first phase or dead travel corresponding to leaving the neutral position of the pusher in which the travel of the pusher does not generate any increase in pressure at the output of a regulating unit,
a second phase corresponding to a regulation jump in which the pressure at the output of the regulating unit suddenly increases, and
a third phase corresponding to more linear operation in which the output pressure of the regulating unit becomes proportional to the travel of the pusher of the hand- or foot-operated hydraulic controller.

These graphical illustrations nevertheless differ from each other as regards the slope of their third phase corresponding to a more linear operation in which the output pressure of the regulating unit 6 becomes proportional to the travel of the pusher 7 of a pressure regulating device 1 of the hand- or foot-operated hydraulic control type as well as on the handling of the force at the end of travel of the actuator 18.

Thus, FIGS. 3 and 5 show a particular position in proximity to the end-of-travel position of the actuator 18 for which a pressure regulation jump occurs at the output of a regulating unit 6 of a pressure regulating device 1 followed by stabilization of this pressure as far as the end-of-travel position.

This second regulation jump is ascribable to the abutment of the plunger 14 on the pusher 7 following compression of the regulating spring.

The plunger 14 may then no longer regulate the pressure and it entirely opens the transverse orifices 17 between the reduced pressure orifice E and the relevant regulated output orifice S1 or S2.

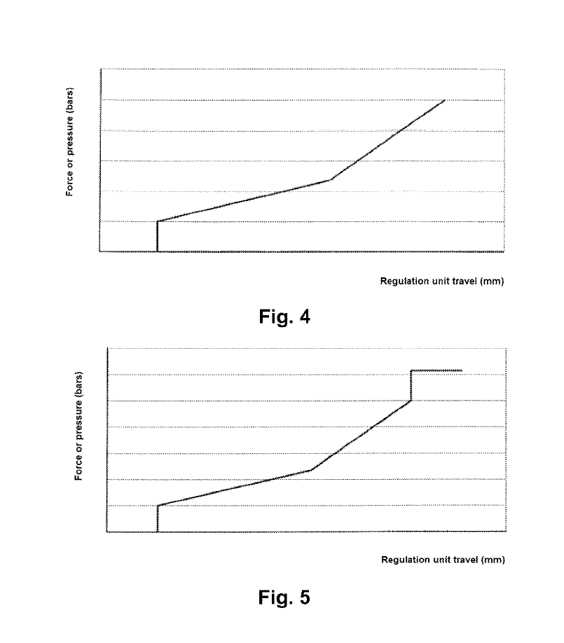

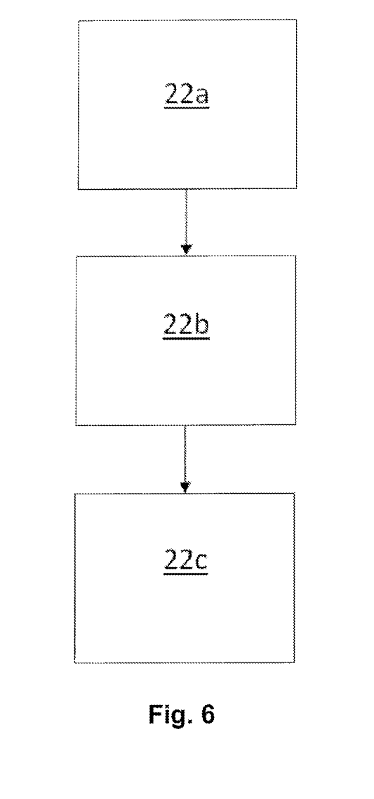

FIGS. 4 and 5 also show two different slopes on the third operating phase of a pressure regulating device 1.

This change in slope is due to particular handling of the force according to the travel of the pusher 7. Thus, substantially at half travel, the force or pressure at the output of a regulating unit 6 of a pressure regulating device 1 will increase more rapidly according to the travel of the pusher 7.

Although the invention has been described in connection with particular exemplary embodiments, it is quite obvious that it is by no means limited thereto and that it comprises all the technical equivalents of the means described as well as their combinations.

1. A pressure regulating device, notably a hand- or foot-operated hydraulic controller for a public works machine of the type including:
a body comprising at least one cavity extending between one end opening onto at least one upper face of the body and a bottom opposite to the opening end,
at least one regulating unit mounted in the body, and comprising a pusher extending between a head and a foot and being at least partly housed in said at least one cavity of the body along an axial direction, said pusher being laid out so as to produce a reciprocal movement between a determined equilibrium position and variable driven-in and/or outward-protruding positions relatively to the equilibrium position,
an actuator extending along an axial direction, intended to be actuated by an operator and comprising a transverse skirt, said actuator being pivotally mounted relatively to the body facing the upper face of said body for controlling the reciprocal movement of said pusher, the skirt bearing upon the head of said pusher, and the axis of the actuator forming with the axis of the pusher a variable angle between a neutral position and variable tilted positions relatively to the neutral position in two opposite directions relatively to the neutral position of the actuator,
said pressure regulating device including electrical or electronic means for determining the position occupied by the actuator or the pusher comprising a sensor of the proportional type including a moveable member according to the movement of the actuator or of a pusher on the one hand and contactless type means for detecting the position of the moveable member interdependent on the body, the moveable member being interdependent on the movement of a pusher and positioned in a cavity of the body, the detection means being positioned outside said cavity.

2. The pressure regulating device according to claim 1, wherein the moveable member comprises at least one magnet and the detection means comprise an electronic element for detecting the magnet.

3. The pressure regulating device according to claim 2, wherein the means for determining the position of the actuator comprise a Hall effect sensor.

4. The pressure regulating device according to claim 1, including several distinct operating phases in each of which the output pressure of the regulating unit is determined according to the positioning of the actuator or of the pusher, the electric or electronic means for determining the position occupied by the actuator or of the pusher being laid out for determining the position occupied by the actuator or the pusher over at least one portion of the two operating phases.

5. The pressure regulating device according to claim 1, wherein the moveable member is mounted on an abutment-cup limiting the upward movement of the pusher to its equilibrium position while the detection means are mounted on a side face of the body facing said side face of the cavity of the body facing which the moveable member is mounted.

6. The pressure regulating device according to claim 1, wherein when the actuator is in its neutral position, the moveable member is placed facing the detection means.

7. An anti-tilting system, for controlling the pressure rise of the [symbol] load sensing [symbol] type, the leaving of the idling speed mode of the heat engine, or the flow distribution of the [symbol] flow sharing [symbol] type, notably for a public works machine, including a pressure regulating device according to claim 1.
